(19) United States
(12) Patent Application Publication
(10) Pub. No.: US 2025/0231149 A1
(43) Pub. Date: Jul. 17, 2025

(54) INSPECTION OF CORROSION RESISTANCE ALLOY WITH MANUAL WELD OVERLAY UTILIZING ZONAL DISCRIMINATION

(71) Applicant: SAUDI ARABIAN OIL COMPANY, Dhahran (SA)

(72) Inventors: Hani Akl, Dekernes (EG); Abdullah Alkhalifah, Dammam (SA)

(73) Assignee: SAUDI ARABIAN OIL COMPANY, Dhahran (SA)

(21) Appl. No.: 18/412,247

(22) Filed: Jan. 12, 2024

(51) Int. Cl. G01N 29/30; B23K 31/12; B23K 103/02; G01N 29/04; G01N 29/26

(52) U.S. Cl. CPC G01N 29/30; B23K 31/125; G01N 29/043; G01N 29/262; B23K 2103/02; G01N 2291/0289; G01N 2291/056; G01N 2291/106; G01N 2291/267

(57) ABSTRACT

A system for non-destructive defect detection includes a calibration block and at least two phased array probes configured to transmit and receive pulsed echo signals. The calibration block includes a base metal having a first surface opposite a second surface, a corrosion resistant alloy coupled to the first surface of the calibration block, and a manual weld overlay extending from the first surface of the calibration block to a second surface of the calibration block. A method for non-destructive defect detection includes providing a system for non-destructive defect detection and calibrating at least two phased array probes of the system for non-destructive defect detection to form at least two calibrated phased array probes.

### BACKGROUND

Weld overlay, also known as weld cladding, is the process of melting a protective layer of metal atop another metal surface. Typically, in the weld overlay process, heat is applied to a cladding metal, melting it onto a base metal material, creating a welded surface which has improved properties, such as greater corrosion or wear resistance.

One specific type of weld overlay is referred to as manual weld overlay or manual weld cladding, where an operator manually applies cladding material (as opposed to, for example, an automatic laser welding process). When a weld is applied internally, for example inside a pipeline in the oil and gas industry, inspection of the weld quality may be difficult. Inspection of weld quality can be done by visual inspection and several non-destructive inspection tests also exist. Some common types of non-destructive inspection testing for weld overlay include magnetic particle inspection, ultrasonic inspection, and radiographic inspection, which use electromagnetic waves, high frequency sound waves, and gamma or x-rays, respectively, to perform weld overlay inspection.

Despite the current non-destructive inspection testing techniques for weld overlay, inspection of manual weld overlay on internal surfaces is particularly difficult due to the irregular shape of the manual weld causing scattering of the waves used in the inspection process. Accordingly, there exists a need for an improved non-destructive testing technique for manual weld overlay on internal surfaces.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a system for non-destructive defect detection. The system includes a calibration block and at least two phased array probes configured to transmit and receive pulsed echo signals. The calibration block includes a base metal having a first surface opposite a second surface, a corrosion resistant alloy coupled to the first surface of the calibration block, and a manual weld overlay extending from the first surface of the calibration block to a second surface of the calibration block.

In another aspect, embodiments herein relate to a method for non-destructive defect detection that includes providing a system for non-destructive defect detection. The system may be as described previously. The method also includes calibrating the at least two phased array probes of the system for non-destructive defect detection to form at least two calibrated phased array probes. Calibrating the at least two phased array probes includes transmitting pulsed echo signals from each of the at least two phased array probes to an opposite side of the manual weld overlay, and receiving the transmitted pulsed echo signals in each of the at least two phased array probes.

Other aspects and advantages of the claimed subject matter will be apparent from the following description and the appended claims.

### BRIEF DESCRIPTION OF DRAWINGS

FIG. 1 shows a system for non-destructive defect detection according to one or more embodiments.

FIG. 2 shows a computer system in accordance with one or more embodiments.

FIG. 3 is an overview of inspection zones according to one or more embodiments.

FIG. 4 shows a simplified diagram of two calibrated probes of a system disposed on a welded sample for analysis in accordance with one or more embodiments.

FIG. 5 shows a flowchart of a method in accordance with one or more embodiments disclosed herein.

FIGS. 6A-6E show a non-limiting example of tracing different zones of a second side of a manual weld overlay with a first probe in accordance with one or more embodiments.

FIG. 7 is an image of a cross-section of corrosion resistant alloy cladding obtained with a system and method in accordance with one or more embodiments.

### DETAILED DESCRIPTION

The ability to accurately inspect manual weld overlay on internal surfaces is crucial to ensuring their integrity. A tandem approach is often employed, which is a technique that is based on the use of one probe that transmits ultrasonic signals and another probe receives them. As a result of the existence of weld-overlay sections, this tandem approach is often unreliable. To overcome the challenges faced when using current manual weld overlay inspection techniques, embodiments herein describe an inspection device and technique to improve non-destructive defect detection for metals, such as corrosion resistance alloy (CRA), with manual weld overlay.

Many common techniques for defect detection utilize a form of inspection that includes calibration of a device that includes near fusion reflectors located proximate to fusion zones. In instances where filled zones are inspected with these traditional techniques, the device and method of use is based on a pitch and catch method of detection, meaning that one probe is located proximate to a fill zone that transmits a signal (e.g., an acoustic or ultrasonic signal) and another probe located proximate to the fill zone receives the signal that is reflected from the fill zone. However, the pitch and catch method is not suitable for manual welding cladding sections, and these techniques can increase beam scattering and noise. For example, the inspection of manual welds is not practical with these techniques as the presence of manual welds (e.g., a manual weld overlay (MWOL)) located inside a pipeline has the propensity to cause scattering of signals (e.g., ultrasonic wave signals).

One or more embodiments presented herein may relate to a system and method for non-destructive defect detection that avoids performing ultrasonic inspection using a first and second ultrasonic leg to interact with a weld overlay. The system and method of one or more embodiments may utilize a pulse echo mode such that the same probe that transmits a signal and receives the signal that is reflected off an inspection surface. In some embodiments, the system and method herein may include one or more components that are configured for performing a Pulse Echo Technique (PET). The PET may be calibrated at a far fusion zone to increase sensitivity, increase the signal to noise ratio (S/N), and decrease signal scattering from cladding of manual welds as compared to traditional techniques described above. The term “pulse echo” refers to a scan that uses ultrasonic signals for thickness and height measurements that identifies indication echoes reflected from a defect (or a location having discontinuity) in a sample material. In one or more particular embodiments, the system and method herein may be used to inspect corrosion resistant alloys that include plate cladding. As such, one or more embodiments presented herein may be used to resolve the inspection challenge of manual welding cladding at an internal surface, including, but not limited to, an internal pipe surface that includes manual welding cladding.

### System for Non-Destructive Defect Detection

In one aspect, embodiments disclosed herein relate to a system for non-destructive defect detection. The system may include a calibration block and at least two phased array probes. The calibration block may be configured to calibrate the at least two phased array probes for weld samples (e.g., weld zones along a pipeline). The calibration block may have an elongated shape in which the calibration block is wider than it is tall. The calibration block may include a base metal, a weld zone, and a corrosion resistant alloy.

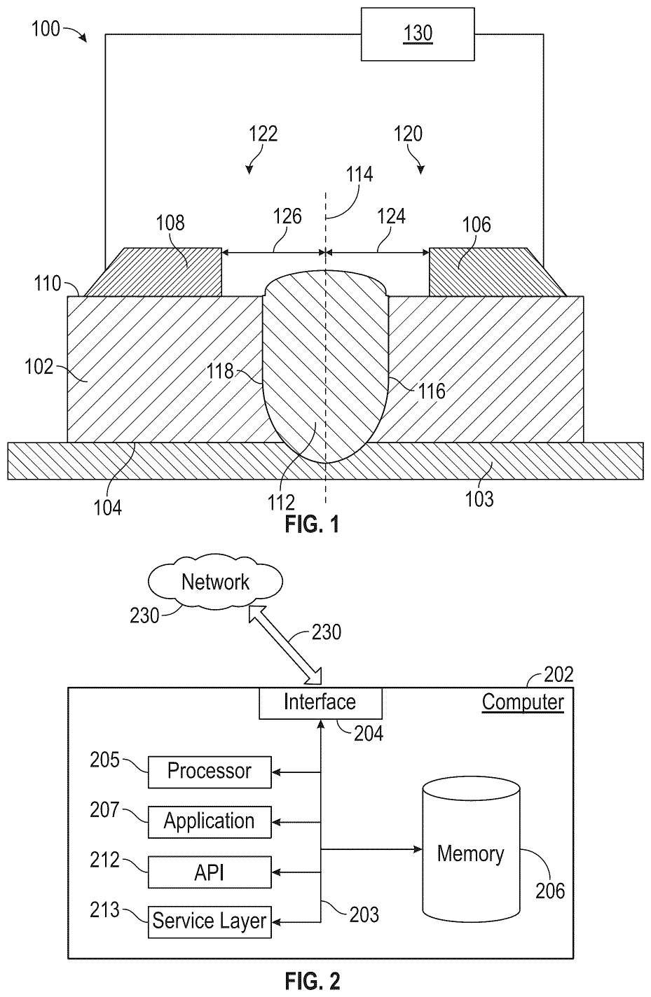

The system of one or more embodiments may be as shown in FIG. 1. The system 100 may include a calibration block that includes a base metal 102. In some embodiments, the calibration block has an elongated shape. The base metal 102 may include carbon steel and be treated with a welding process that includes an alloy material. Non-limiting examples of alloy material includes grade 625 alloy, which includes a nickel-chromium-molybdenum alloy. The thickness of the calibration block may be the same thickness of the material that is used in production stages (e.g., pipeline production) with a manual cladding or lining having a thickness in a range from 2.5 mm (millimeters) to 3.5 mm. For example, the manual cladding or lining may have a thickness of about 3 mm.

A corrosion resistant alloy 103 may be coupled to a first surface 104 of the base metal 102. Corrosion resistant alloy 103 may be welded to the first surface 104 of the base metal 102. Corrosion resistant alloy 103 may include the manual cladding or lining as described previously. As one of ordinary skill may appreciate, the corrosion resistant alloy 103 may have a thickness that relates to thickness ranges present in field applications. In some embodiments, the system includes at least two probes, such as a first probe 106 located opposite to a second probe 108, located on the same surface of the base metal 102 (e.g., surface 110). The at least two probes may be manually held in place during calibration of the probe. In some embodiments, the at least two probes are coupled to the calibration block at an location in an area proximate to a weld location. In such embodiments, the material used for coupling includes water applied either manually or automatically. Base metal 102 may include a welded section that includes a manual weld overlay 112. The manual weld overlay 112 may extend from the first surface 104 of base metal 102 through the base metal 102 to the second surface 110 of base metal 102. In one or more particular embodiments, the manual weld overlay 112 extends from a location in the corrosion resistant alloy 103 to a location proximate to the second surface 110 of the base metal 102.

Base metal 102 may have a thickness that corresponds to a metal thickness that is used in field applications and is suitable for welding. In a non-limiting example, base metal 102 may have a thickness in a range having a lower limit of any one of 20, 22, 24, 26, and 28 mm with an upper limit of any one of 24, 25, 26, 27, 28, 29, and 30 mm, where any lower limit can be paired with any mathematically compatible upper limit. In one or more particular embodiments, the thickness of the base metal 102 is in a range from 26 mm (millimeters) to 27 mm. For example, the thickness of the base metal 102 may be 26.64 mm.

Each of the probes of the system may include a transducer assembly (not shown). The transducer assembly may include a plurality of transducer elements configured to emit ultrasonic waves. In some embodiments, the transducer assembly includes 60 to 70 transducer elements. For example, the transducer assembly may include 60 or more transducer elements, 62 or more transducer elements, 64 or more transducer elements, or 66 or more transducer elements. The number of transducer elements of the transducer assembly may be adjusted for different weld sizes. For example, larger weld sizes may require more than 60 transducer elements, more than 64 transducer elements, or more than 70 transducer elements. In some embodiments, a “large weld size” refers to a weld thickness of more than 25 mm (millimeters). A “normal” or “small” weld size may refer to a weld having a thickness of 25 mm or less. Alternatively, the number of transducer elements of the transducer assembly may be decreased (e.g., adjusted to 60 transducer elements or less) for smaller weld sizes. In one or more particular embodiments, the transducer assembly includes 64 transducer elements. In some embodiments, the transducer elements of the phased array probe are configured to emit ultrasonic waves at a frequency in a range from 4.5 to 8 MegaHertz (MHz). The transducer elements of the phased array probe may emit ultrasonic waves having a frequency in a range with a lower limit of any one of 4.5, 5, 5.5, and 6 and an upper limit of any one of 5.5, 6, 6.5, 7, 7.5, and 8 MHz. In some embodiments, one or more settings of the phased array probe (e.g., one or more settings of the transducer assembly, the transducer elements, or both) can be adjusted depending on the thickness of the weld to be examined.

A first probe 106 and a second probe 108 may be installed at a second surface 110 of the base metal 102. In one or more embodiments, the first probe 106 may be installed at a location opposite to the second probe 108 on the second side of the base metal 102. As mentioned above, the first probe 106 and the second probe 108 may be phased array probes configured to transmit and receive pulse echo signals. Pulse echo signals may refer to a high-frequency acoustic pulse emitted by an ultrasonic transducer (i.e., the transducer assembly) of each of the at least two phased array probes (e.g., probes 106 and 108) that may independently be in transmit mode. The high-frequency acoustic pulse may be emitted from the ultrasonic transducer from a phased array probe toward a side of a weld zone opposite to the probe, where the high-frequency acoustic pulse is reflected back to the same transducer that is operating in receive mode. In some embodiments, the ultrasonic signal measurement that is transmitted from the at least two probes (e.g., probes 106 and 108) to a computer system 130 may include an amplitude of the received signal, a time between signal emission and signal reception, a full waveform of the received signal, and combinations thereof.

The system for non-destructive defect detection may be coupled to one or more computer systems such that probe calibration data is stored, weld inspection may be visualized on a computer screen, defects may be identified, or combinations thereof. The computer system may be configured to receive data transmitted from the at least two probes of the system for non-destructive defect detection. The data transmitted may be stored as calibration data, transformed into a visual image, transformed into defect characterization information, or combinations thereof. The computer system may be as described in the following section and in FIG. 2.

The at least two probes may be in electrical connection with a computer system. For example, data regarding the ultrasonic wave information (i.e., “ultrasonic signals”) transmitted by and received in the probes may be transferred and stored on a storage medium, may be downloaded using a computer, or both. In one or more embodiments, calibration data can be stored on a storage medium, may be downloaded using a computer or both such that the calibrated probes can be used to analyze multiple locations having the same weld thickness. In some embodiments, the transferred ultrasonic signal data may be visualized on a computer monitor of a computer of the computer system. FIG. 2 is a block diagram of a computer system (202) used to provide computational functionalities associated with described algorithms, methods, functions, processes, flows, and procedures as described in the instant disclosure, according to an implementation. The illustrated computer (202) is intended to encompass any computing device such as a high-performance computing (HPC) device, a server, desktop computer, laptop/notebook computer, wireless data port, smart phone, personal data assistant (PDA), tablet computing device, one or more processors within these devices, or any other suitable processing device, including both physical or virtual instances (or both) of the computing device. Additionally, the computer (202) may include a computer that includes an input device, such as a keypad, keyboard, touch screen, or other device that can accept user information, and an output device that conveys information associated with the operation of the computer (202), including digital data, visual, or audio information (or a combination of information), or a GUI.

The computer (202) can serve in a role as a client, network component, a server, a database or other persistency, or any other component (or a combination of roles) of a computer system for performing the subject matter described in the instant disclosure. The illustrated computer (202) is communicably coupled with a network (230). In some implementations, one or more components of the computer (202) may be configured to operate within environments, including cloud-computing-based, local, global, or other environment (or a combination of environments).

At a high level, the computer (202) is an electronic computing device operable to receive, transmit, process, store, or manage data and information associated with the described subject matter. According to some implementations, the computer (202) may also include or be communicably coupled with an application server, e-mail server, web server, caching server, streaming data server, business intelligence (BI) server, or other server (or a combination of servers).

The computer (202) can receive requests over network (230) from a client application (for example, executing on another computer (202)) and responding to the received requests by processing the said requests in an appropriate software application. In addition, requests may also be sent to the computer (202) from internal users (for example, from a command console or by other appropriate access method), external or third-parties, other automated applications, as well as any other appropriate entities, individuals, systems, or computers.

Each of the components of the computer (202) can communicate using a system bus (203). In some implementations, any or all of the components of the computer (202), both hardware or software (or a combination of hardware and software), may interface with each other or the interface (204) (or a combination of both) over the system bus (203) using an application programming interface (API) (212) or a service layer (213) (or a combination of the API (212) and service layer (213). The API (212) may include specifications for routines, data structures, and object classes. The API (212) may be either computer-language independent or dependent and refer to a complete interface, a single function, or even a set of APIs. The service layer (213) provides software services to the computer (202) or other components (whether or not illustrated) that are communicably coupled to the computer (202). The functionality of the computer (202) may be accessible for all service consumers using this service layer. Software services, such as those provided by the service layer (213), provide reusable, defined business functionalities through a defined interface. For example, the interface may be software written in JAVA, C++, or other suitable language providing data in extensible markup language (XML) format or other suitable format. While illustrated as an integrated component of the computer (202), alternative implementations may illustrate the API (212) or the service layer (213) as stand-alone components in relation to other components of the computer (202) or other components (whether or not illustrated) that are communicably coupled to the computer (202). Moreover, any or all parts of the API (212) or the service layer (213) may be implemented as child or sub-modules of another software module, enterprise application, or hardware module without departing from the scope of this disclosure.

The computer (202) includes an interface (204). Although illustrated as a single interface (204) in FIG. 4, two or more interfaces (204) may be used according to particular needs, desires, or particular implementations of the computer (202). The interface (204) is used by the computer (202) for communicating with other systems in a distributed environment that are connected to the network (230). Generally, the interface (204 includes logic encoded in software or hardware (or a combination of software and hardware) and operable to communicate with the network (230). More specifically, the interface (204) may include software supporting one or more communication protocols associated with communications such that the network (230) or interface's hardware is operable to communicate physical signals within and outside of the illustrated computer (202).

The computer (202) includes at least one computer processor (205). Although illustrated as a single computer processor (205) in FIG. 2, two or more processors may be used according to particular needs, desires, or particular implementations of the computer (202). Generally, the computer processor (205) executes instructions and manipulates data to perform the operations of the computer (202) and any algorithms, methods, functions, processes, flows, and procedures as described in the instant disclosure.

The computer (202) also includes a memory (206) that holds data for the computer (202) or other components (or a combination of both) that can be connected to the network (230). For example, memory (206) can be a database storing data consistent with this disclosure. Although illustrated as a single memory (206) in FIG. 2, two or more memories may be used according to particular needs, desires, or particular implementations of the computer (202) and the described functionality. While memory (206) is illustrated as an integral component of the computer (202), in alternative implementations, memory (206) can be external to the computer (202).

Application (207) is an algorithmic software engine providing functionality according to particular needs, desires, or particular implementations of the computer (202), particularly with respect to functionality described in this disclosure. For example, application (207) can serve as one or more components, modules, applications, etc. Further, although illustrated as a single application (207), the application (207) may be implemented as multiple applications (207) on the computer (202). In addition, although illustrated as integral to the computer (202), in alternative implementations, the application (207) can be external to the computer (202).

There may be any number of computers (202) associated with, or external to, a computer system containing computer (202), each computer (202) communicating over network (230). Further, the term “client,” “user,” and other appropriate terminology may be used interchangeably as appropriate without departing from the scope of this disclosure. Moreover, this disclosure contemplates that many users may use one computer (202), or that one user may use multiple computers (202).

In some embodiments, the computer (202) is implemented as part of a cloud computing system. For example, a cloud computing system may include one or more remote servers along with various other cloud components, such as cloud storage units and edge servers. In particular, a cloud computing system may perform one or more computing operations without direct active management by a user device or local computer system. As such, a cloud computing system may have different functions distributed over multiple locations from a central server, which may be performed using one or more Internet connections. More specifically, cloud computing system may operate according to one or more service models, such as infrastructure as a service (IaaS), platform as a service (PaaS), software as a service (SaaS), mobile “backend” as a service (MBaaS), serverless computing, artificial intelligence (AI) as a service (AIaaS), and/or function as a service (FaaS).

Referring back to FIG. 1, the first probe 106 and the second probe 108 may each be in electrical communication with a computer system 130. The computer system 130 may be as described above. In some embodiments, the computer system 130 is configured to receive and store data obtained from the two or more probes of the system. The data transmitted to computer system 130 from the at least two probes may include calibration data that includes an ultrasonic signal measurement of a calibration block, an ultrasonic signal measurement of a welded sample, or both. A “welded sample” refers to a sample having a welded area that is analyzed after the at least two probes are calibrated. In some embodiments, probe calibration data may be used to analyze one or more welded areas (e.g., one or more welded areas in a pipeline) that were produced with the same welding process as was used to produce the manual weld overlay 112 of the base metal 102.

As shown in FIG. 1, the welded section including the manual weld overlay 112 may have a central axis 114 that divides first and second sides (e.g., sides 116 and 118) of the manual weld overlay 112 and first and second sides (e.g., sides 120 and 122) of the base metal 102. The first and second sides (e.g., sides 116 and 118) of the manual weld overlay zone may each include a plurality of weld fusion zones. The first probe 106 may be located a first distance 124 from central axis 114 on the first side of the base metal 102. The placement of the first and second probe with respect to a distance from central axis 114 may depend upon on the thickness of the weld zone being inspected. The first probe 106 and the second probe 108 may each be configured to transmit a signal to an opposite side of the manual weld overlay 112. The “opposite side of the manual weld overlay zone” refers to a side of the manual weld overlay 112 that is opposite to the location of the probe from central axis 114. For example, probe 106 may transmit a signal to side 118 and probe 108 may transmit a signal to side 116. Probe 106 may be configured to receive the transmitted signal reflected from side 118. Probe 108 may be configured to receive a transmitted signal reflected from side 116. In one or more embodiments, the corrosion resistant alloy 103 and the probes (e.g., first probe 106 and second probe 108) are coupled to opposite surfaces of the base metal 102.

In some embodiments, the first probe 106 is configured to analyze a plurality of weld fusion zones located in the second side 118 of the manual weld overlay 112. The second probe 108 may be located a second distance 126 from central axis 114 on the first side of the base metal 102. In such embodiments, the second probe 108 is configured to analyze the plurality of weld fusion zones located in the first side 116 of the manual weld overlay 112. The base metal 102 may be configured to calibrate the first probe 106 and the second probe 108 through far fusion zone analysis.

In some embodiments, the system includes one or more gates that cover a central axis of the manual weld overlay to a far fusion line. The system may include two or more gates, three or more gates, four or more gates, or five or more gates. In some embodiments, the number of gates in the system corresponds to weld size to be measured. In one or more particular embodiments, the system includes four or more gates.

As mentioned above, the welded section that includes a manual weld overlay 112 may include a plurality of weld fusion zones in each of the first and second sides (e.g., sides 116 and 118) of the manual weld overlay 112. The plurality of weld fusion zones of each of sides 116 and 118 may include two or more weld fusion zones. The plurality of weld fusion zones of each of sides 116 and 118 may include three or more weld fusion zones. The plurality of weld fusion zones of each of sides 116 and 118 may include four or more weld fusion zones. The plurality of weld fusion zones of each of sides 116 and 118 may include five or more weld fusion zones. The plurality of weld fusion zones of each of sides 116 and 118 may include six or more weld fusion zones. Each weld zone may have a thickness in a range from 0.75 mm to 3.5 mm depending on the weld profile and wall thickness of the weld zone. Each weld zone may include a calibration reflector zone to reflect incident signals emitted from one or more transducer elements of the probe.

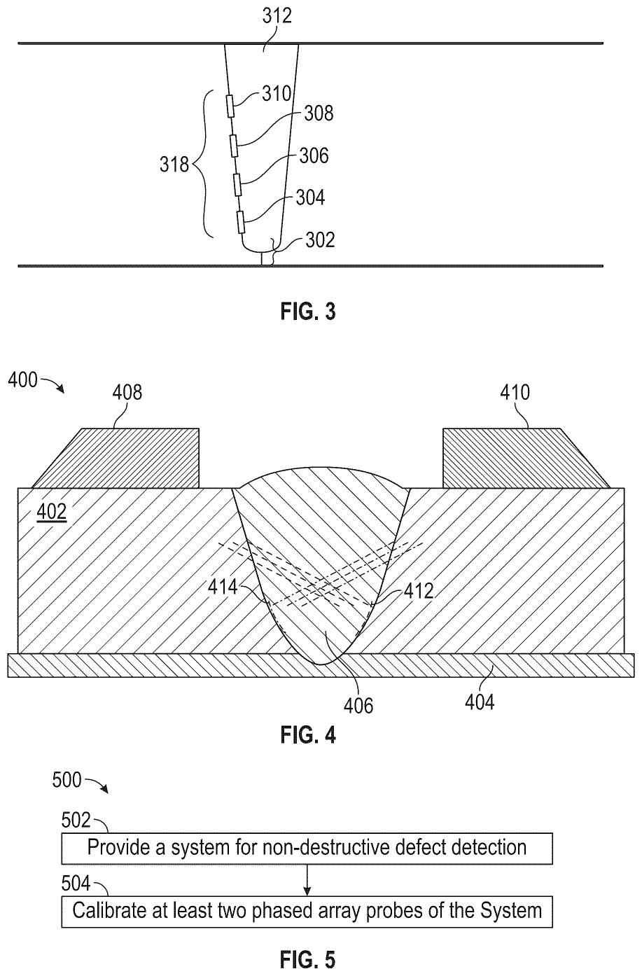

In some embodiments, the plurality of weld fusion zones of the second side 318 of the manual weld overlay 312 are as shown in FIG. 3. The plurality of weld zones of second side 318 may be a far fusion zone with respect to a first probe (e.g., probe 106 of FIG. 1). In some embodiments, the plurality of weld zones of the first side of the manual weld overlay 312 are arranged opposite to the plurality of weld zones of the second side 318 of the manual weld overlay 312. In such embodiments, the plurality of weld fusion zones of the first side may be a far fusion zone with respect to a second probe (e.g., probe 108 of FIG. 1).

As shown in FIG. 3, the manual weld overlay 312 may include a root zone 302 located proximate to the first surface of the base metal. The root zone 302 may be a portion of the weld overlay section that includes area proximate to and surrounding a central axis of the manual weld overlay 312. The plurality of weld fusion zones may be vertically arranged along the second side 318 as shown in FIG. 3. In such embodiments, the plurality of weld fusion zones of the second side 318 includes at least four weld fusion zones (e.g., zones 304-310). Weld fusion zones 304-310 may include a flat bottom hole having a length in a range from 0.75 mm to about 3.5 mm. Weld fusion zones 304 through 310 may have a length in a range with a lower limit of any one of 0.75 mm, 1 mm, 1.5 mm, 2 mm, and 2.5 mm and an upper limit of any one of 2.5 mm, 3 mm, and 3.5 mm, where any lower limit can be paired with any mathematically compatible upper limit.

FIG. 4 shows a simplified diagram of two calibrated probes of a system 400 disposed on a welded sample for analysis in accordance with one or more embodiments. The two calibrated probes 408 and 410 may be located on either side of a welded section 406 of a welded sample 402 as shown in FIG. 4. A corrosion resistant alloy 404 may be coupled of the welded sample 402 opposite to the two calibrated probes 408 and 410. The two calibrated probes may be phased array probes configured to transmit and receive pulse echo signals. In some embodiments, the calibrated probes are configured to initiate automatic ultrasonic testing (AUT), pulse echo signal emission, or both for weld inspection on a base metal, a corrosion resistant alloy, or combinations thereof. The first probe 408 and a second probe 410 may each configured to transmit a plurality of ultrasonic waves to a side of the welded section 406 that is opposite from each probe (i.e., a far fusion zone). For example, probe 408 may transmit a signal to side 412 and probe 410 may transmit a signal to side 414. Probe 408 may be configured to receive the transmitted signal reflected from side 412. Probe 410 may be configured to receive a transmitted signal reflected from side 414.

The welds inspected by the at least two probes may include a manual weld overlay with manual weld cladding, girth welds, or both. The term “girth welds” may include welds that are obtained from arc welding processes and applied in the joining of two pipes along a circumference of a pipe during phase construction of a pipeline, thereby making circumferential welds in pipeline, such as in a pipeline for underground systems.

### Method for Non-Destructive Defect Detection

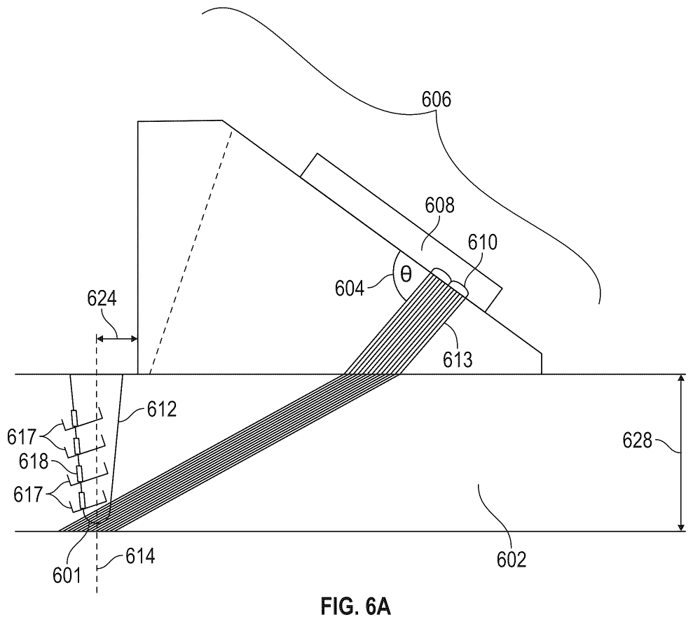

In another aspect, embodiments disclosed herein relate to a method for non-destructive defect detection. FIG. 5 shows a flowchart providing a non-limiting method 500 in accordance with one or more embodiments. The method 500 may include block 502 that provides a system for non-destructive defect detection. The system may be as described above, which includes at least two probes that may be phased array probes and a calibration block. The at least two phased array probes may each transmit and receive pulse echo signals to and from a far fusion zone of a weld overlay. The far fusion zone may be a side of a weld overlay opposite from a probe as described above.

The method 500 of one or more embodiments may include block 504, which includes calibrating the at least two probes with the calibration block. In such embodiments, calibrating the at least two probes include transmitting pulsed echo signals from each of the at least two probes to an opposite side of the manual weld overlay (i.e., a far fusion zone) of the calibration block, and receiving the transmitted pulsed echo signals in the same probe from which the signals were emitted. In some embodiments, the base metal of the calibration block refracts the pulse echo signals emitted from the at least two probes such that the refracted pulse echo signals are transmitted to the far fusion zone. The transmitted pulsed echo signals may be reflected from a plurality of weld zones located in a side of a manual weld overlay opposite to the probe that originally transmitted the pulsed echo signals. In some embodiments, measurements obtained from the calibration block are transmitted from the at least two probes to a computer system as calibration data.

The method 500 may include evaluating a welded sample with the at least two calibrated phased array probes. In some embodiments, measurements obtained from evaluation of the welded sample are transmitted from the at least two probes to the computer system as sample measurement data. The sample measurement data may be compared against calibration data to generate an image of the weld zone including weld defects on a computer screen. In some embodiments, the sample measurement data is processed prior to generating a visual profile of an image of the weld zone on a computer screen. For example, the sample measurement data may be normalized using the calibration data prior to generating a visual profile. The sample measurement data may be offset using the calibration data prior to generating a visual profile. In some embodiments, a sectoral phased array scan is performed with the at least two probes is used to measure volumetric indication of the calibration block, the welded sample, or both. In some embodiments, areas of the calibration block, the welded sample, or both that are not covered by incident signals or a pulse channel of the at least two probes are analyzed with a creep probe.

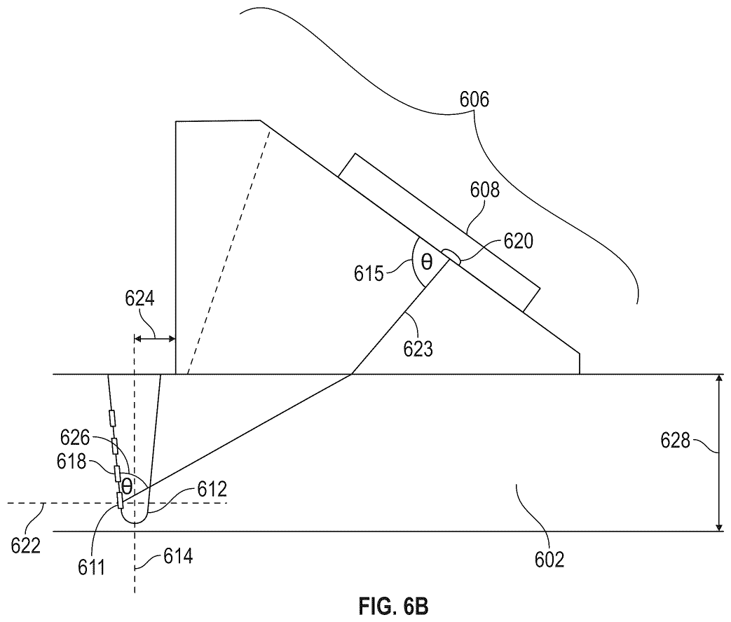

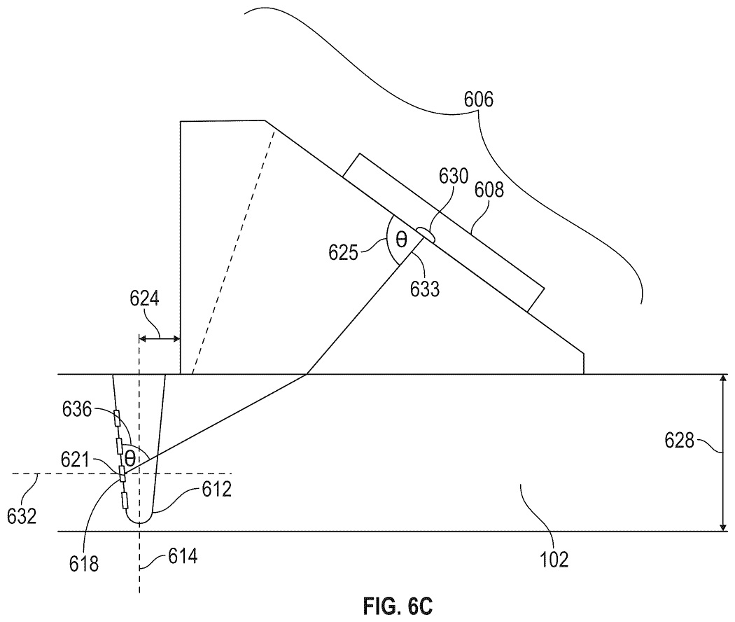

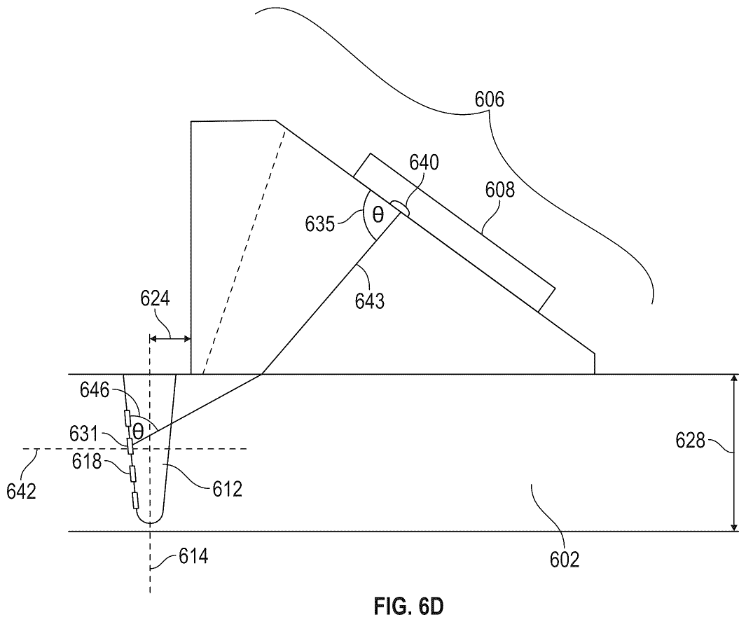

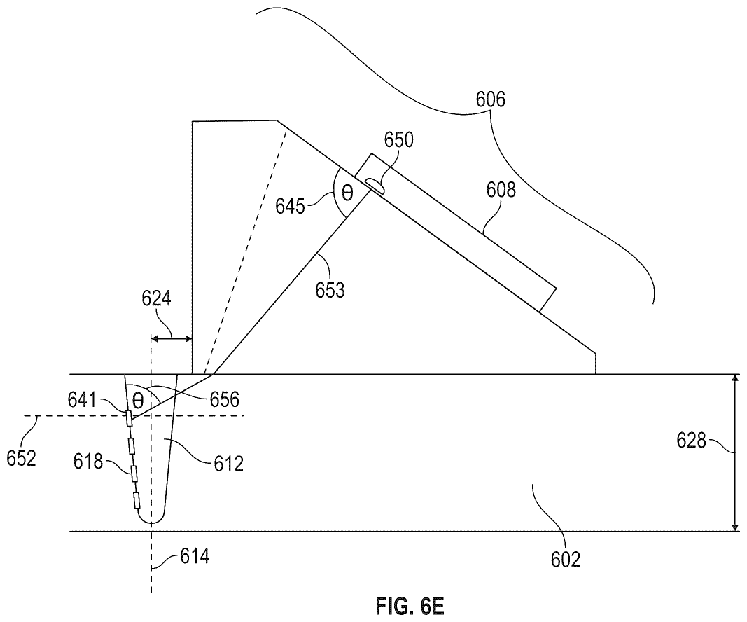

A visual representation of a non-limiting example for calibrating one of the at least two probes may be as shown in FIGS. 6A to 6E. In some embodiments, one or more additional probes may be calibrated in the same manner as shown in FIGS. 6A to 6E. FIG. 6A shows the first probe 606 located on a base metal 602 of a calibration block. Base metal 602 includes a manual weld overlay 612 having a second side 618. The base metal may have a thickness 628 of at least 26 mm (e.g., 26.64 mm as shown in FIGS. 6A to 6E). As shown in FIG. 6A, the first side of the probe is positioned at a distance 624 away from the central axis 614 of the manual weld overlay 612. This distance 624 may be 7 mm as shown in FIG. 6A. As mentioned previously, the distance 624 may depend upon the thickness of the zone to be inspected. For example, if a welded zone has a thickness of more than 26.64 mm, the probe placement could be adjusted to ensure total inspection coverage, which can be prepared with a scan plan. In some embodiments, the distance 624 may be in a range a range as described above.

The first probe 606 may include a transducer assembly 608, and root transducer elements 610. The base metal 602 includes a manual weld overlay 612. As shown in FIG. 6A, a calibration system may include one or more gates 617. Calibration of probe 606 may include evaluation of root zone 601 of a manual weld overlay 612. A plurality of root incident signals 613 may be generated and emitted from one or more root transducer elements 610 of probe 606. In some embodiments, the plurality of root incident signals 613 are emitted in pulse echo mode from probe 606. The plurality of root incident signals 613 may be transmitted at an inspection angle 604 to the calibration block. The inspection angle 604 of root incident signals 613 may be in a range with a lower limit of any one of 88, 89, and 90° and an upper limit of any one of 90, 91, and 92°, where a lower limit can be paired with a mathematically compatible upper limit. In some embodiments, the inspection angle 604 of the root incident signals 613 is positioned at right angles with respect to the transducer assembly. In such embodiments, the plurality of root incident signals 613 are transmitted to the far fusion zone (i.e., the opposite side of manual weld overlay 612 from probe 606). The plurality of root incident signals 613 may be refracted by the calibration block and transmitted to root zone 601 of the manual weld overlay 612. The signals transmitted to root zone 601 may be reflected back to probe 606 by a calibration reflector of the root zone such that probe 606 receives the signals reflected from root zone 601. In one or more embodiments, the amplitude of the signal reflected to probe 606 from the far fusion zone may be a higher amplitude response, which may be generated from weld defects, as compared to a probe that is used for near fusion zone analysis.

Probe 606 may analyze the first weld zone as shown in FIG. 6B. In such embodiments, probe 606 may include a transducer assembly that includes a first transducer element 620. The first transducer element 620 may produce one or more incident signals 623 (e.g., a pulse echo signal) at an inspection angle 615 in a range from 88 to 92 degrees from the transducer assembly. The inspection angle 615 of incident signals 623 may be in a range with a lower limit of any one of 88, 89, and 90° and an upper limit of any one of 90, 91, and 92°, where a lower limit can be paired with a mathematically compatible upper limit. The inspection angle 615 may be positioned at a right angle with respect to the transducer assembly.

Incident signal 623 may be transmitted from the transducer element 620 of the probe 606 to a first weld zone 611. In some embodiments, the base metal 602 diffracts the incident signal 623 transmitted to the first weld zone 611. In such embodiments, the first weld zone 611 includes a first reflection line 622 that intersects the transmitted signal 623 at a first reflection angle 626. In some embodiments, the first reflection angle 626 is at least 63 degrees (e.g., 64.8 degrees) as shown in FIG. 6B. In such embodiments, the transmitted signal 623 is reflected back to probe 606 by a calibration reflector of the first weld zone 611. In one or more embodiments, the amplitude of the signal reflected to probe 606 from the far fusion zone may be a higher amplitude response as compared to a probe that is used for near fusion zone analysis, which indicates weld defects.

The probe 606 may analyze a second weld zone 621 as shown in FIG. 6C. In such embodiments, the probe 606 may include a transducer assembly 608 that includes a second transducer element 630. The second transducer element 630 may produce one or more incident signals 633 (e.g., a pulse echo signal) at an inspection angle 625 in a range from 88 to 92 degrees from the transducer assembly. The inspection angle 625 of incident signal 633 may be in a range with a lower limit of any one of 88, 89, and 90° and an upper limit of any one of 90, 91, and 92°, where a lower limit can be paired with a mathematically compatible upper limit. The inspection angle 625 may be positioned at a right angle with respect to the transducer assembly.

Incident signal 633 may be transmitted from the second transducer element 630 of probe 606 and transmitted to a second weld zone 621. In some embodiments, the base metal 602 diffracts the incident signal 633 transmitted to the second weld zone 621. In such embodiments, the second weld zone 621 includes a second reflection line 632 that intersects the transmitted incident signal 633 at a second reflection angle 636. In some embodiments, the second reflection angle 636 is at least 63 degrees (e.g., 64.8 degrees) as shown in FIG. 6C. In such embodiments, the transmitted incident signal 633 is reflected back to probe 606 by a calibration reflector of the second weld zone 621. In one or more embodiments, the amplitude of the signal reflected to probe 606 from the far fusion zone may be a higher amplitude response as compared to a probe that is used for near fusion zone analysis, which indicates weld defects.

Probe 606 may analyze a third weld zone 631 as shown in FIG. 6D. In such embodiments, probe 606 may include a transducer assembly 608 that includes a third transducer element 640. The third transducer element 640 may emit an incident signal 643 (e.g., a pulse echo signal) at an inspection angle 635 in a range from 88 to 92 degrees. The inspection angle 635 of incident signal 643 may be in a range with a lower limit of any one of 88, 89, and 90° and an upper limit of any one of 90, 91, and 92°, where a lower limit can be paired with a mathematically compatible upper limit. The inspection angle 635 may be positioned at a right angle with respect to the transducer assembly.

Incident signal 643 may be transmitted from the third transducer element 640 of probe 606 and transmitted to third weld zone 631. In some embodiments, the base metal 602 diffracts the incident signal 643 transmitted to the third weld zone 631. In such embodiments, the third weld zone 631 includes a third reflection line 642 that intersects the transmitted incident signal 643 at a third reflection angle 646. In some embodiments, the third reflection angle 646 is at least 63 degrees (e.g., 65.3 degrees) as shown in FIG. 6D. In such embodiments, the transmitted incident signal 643 is reflected back to probe 606 by a calibration reflector of the third weld zone 631. In one or more embodiments, the amplitude of the signal reflected to probe 606 from the far fusion zone may be a higher amplitude as compared to a probe that is used for near fusion zone analysis response, which indicates weld defects.

Probe 606 may analyze a fourth weld zone 641 as shown in FIG. 6E. In such embodiments, probe 606 may include a transducer assembly 608 that includes a fourth transducer element 650. The fourth transducer element 650 may emit an incident signal 653 (e.g., a pulse echo signal) at an inspection angle 645 in a range from 88 to 92 degrees. The inspection angle 645 of incident signal 653 may be in a range with a lower limit of any one of 88, 89, and 90° and an upper limit of any one of 90, 91, and 92°, where a lower limit can be paired with a mathematically compatible upper limit. The inspection angle 645 may be positioned at a right angle with respect to the transducer assembly.

Incident signal 653 may be transmitted from the transducer element 650 of the probe 606 and transmitted to fourth weld zone 641. In some embodiments, the base metal 602 diffracts the incident signal 653 transmitted to the fourth weld zone 641. In such embodiments, the fourth weld zone 641 includes a fourth reflection line 652 that intersects the transmitted incident signal 653 at a fourth reflection angle 656. In some embodiments, the fourth reflection angle 656 is at least 63 degrees (e.g., 65.3 degrees) as shown in FIG. 6E. In such embodiments, the transmitted incident signal 653 is reflected back to probe 606 by a calibration reflector of the fourth weld zone 641. In one or more embodiments, the amplitude of the signal reflected to probe 606 from the far fusion zone may be a higher amplitude response as compared to a probe that is used for near fusion zone analysis which indicates weld defects.

In some embodiments, the transducer elements of FIGS. 6A to 6E are configured to operate at the same time such that the incident signals are emitted at the same time intervals. One or more transducer elements may be configured to operate at different operation times such that one or more incident signals are emitted from the probe to the far fusion zone at different times intervals.

In some embodiments, a second probe is calibrated with a first side of the manual weld overlay in the same manner as described in FIGS. 6A through 6E. As noted above, the first side of the manual weld overlay may be opposite to the second side of the manual weld overlay such that the first side of the manual weld overlay is a far fusion zone with respect to the second probe. The first side of the manual weld overlay may include a root zone and a plurality of weld zones. The second probe may transmit and receive signals reflected from the plurality of weld zones and the root zone. In one or more embodiments, the amplitude of the signal reflected to probe 606 from the far fusion zone may be a higher amplitude response from weld defects as compared to a probe that is used for near fusion zone analysis.

In some embodiments, one or more gates cover past a weld center line to a far fusion line to cover any potential lack of fusion zones. In such embodiments, a volume (i.e., sound level) of the incident signals generated from each of the at least two phased array probes is adjusted to be in a range from 5 db (decibels) to 15 db. In some embodiments, the incident signals generated from each of the at least two phased array probes is adjusted to be in a range with a lower limit of any one of 5, 5.5, 6, 7, 7.5, 8, 9 and 10 db and an upper limit of any one of 7.5, 8, 9, 10, 12, 14, and 15 db, where any lower limit can be paired with any mathematically compatible upper limit. In some embodiments, the method includes adjusting a volume of an incident signal from one or more adjacent zones from 6 dB (decibels) to 14 dB. The one or more adjacent zones may refer to one or more zones (e.g., a root zone, a first weld zone, a second weld zone, a third weld zone, or a fourth weld zone, etc.) adjacent to a weld zone of interest.

The amplitude of the sound level may be adjusted to a range from 75 to 99% full screen height. The amplitude of the sound level generated from each of the at least two phased array probes may be adjusted to a value in a range with a lower limit of any one of 75, 80, 85, 88, 90, and 95% full screen height an upper limit of any one of 82, 85, 90, 95, 97, and 99% full screen height, where any lower limit can be paired with any mathematically compatible upper limit.

As the presence of manual welding cladding on an internal surface of the manual weld overlay can affect the accuracy of the defect height measurements, the sensitivity of the at least two phase array probes may be adjusted. In some embodiments, calibrating the at least two phased array probes includes adjusting a sensitivity for one or more signals received from one or more calibration reflectors by each of the at least two phased array probes. In such embodiments, an amplitude of one or more signals reflected from one or more calibration reflectors may be adjusted to be 75% full screen height. The term “full screen height” may refer to the height of a computer screen. Calibrating the at least two phased array probes may include adjusting the amplitude of the signal transmitted from a calibration reflector to be 80% full screen height. In such embodiments, the amplitude may be adjusted to a value in a range with a lower limit of any one of 75, 80, 85, 88, 90, and 95% full screen height an upper limit of any one of 82, 85, 90, 95, 97, and 99% full screen height, where any lower limit can be paired with any mathematically compatible upper limit.

### EXAMPLES

A sample was produced having four (4) defects with different lengths. Table 1, below, provides the length (in mm) of each defect. Table 1 also provides comparative measurement analyses that were determined using inventive and comparative methods. The inventive method was performed in accordance with one or more embodiments described previously. The comparative method was performed using near-fusion analysus.

TABLE 1
Analysis of four defects including actual defect length, and lengths
obtained with an existing technique and an inventive technique.

| | Defect (1) | Defect (2) | Defect (3) | Defect (4) |
|---|---|---|---|---|
| Actual length | 9 mm | 15 mm | 15 mm | 23 mm |
| Comparative | 2 mm | 10 mm | 10 mm | 22 mm |
| Method | | | | |
| Inventive | 11 mm | 17 mm | 17 mm | 24 mm |
| Method | | | | |

As shown in above in Table 1, the inventive technique provides greater accuracy in measuring defects as compared to the existing technique. For example, the existing technique indicates that the defects are shorter in length than their actual length. In contrast, the inventive technique provides a measurement within 2 mm of the actual length. In this respect, the inventive technique aligns with regulations that require that the detected length shall be equal or more than the actual length.

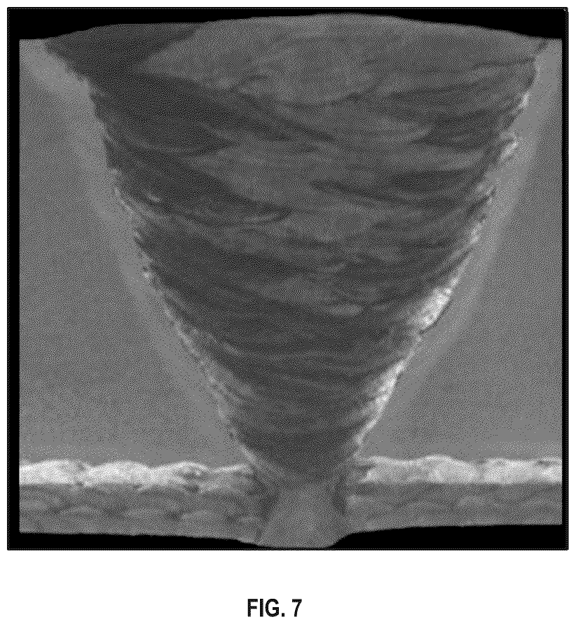

FIG. 7 is an image of a cross-section of corrosion resistant alloy cladding, which was obtained using macro examination where the weld is polished and etched. As shown in FIG. 7, one or more embodiments herein may resolve the inspection challenge of manual welding cladding at internal surfaces and assist in provided more well-defined delineations and defects of a weld zone. One or more embodiments herein may reduce or avoid entirely scattered reflection signals from manual cladding.

Embodiments of the present disclosure may provide at least one of the following advantages. One or more embodiments presented herein may improve the probability of detection (POD) and avoid missing critical defects that can be present after welding, such as defects associated with gas metal arc welding (GMAW, also known as wire welding). In some embodiments, the systems and methods described herein can be applied for evaluation of weld overlays and bonded clad pipelines.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A system for non-destructive defect detection, comprising:
a calibration block comprising:
a base metal having a first surface opposite a second surface;
a corrosion resistant alloy coupled to the first surface of the calibration block; and
a manual weld overlay extending from the first surface of the calibration block to a second surface of the calibration block; and
at least two phased array probes configured to transmit and receive pulsed echo signals.

2. The system of claim 1, wherein the at least two phased array probes include a first probe and a second probe.

3. The system of claim 2, wherein the first probe and the second probe are located on the first surface of the base metal.

4. The system of claim 1, further comprising one or more gates that cover a central axis of the manual weld overlay to a far fusion line.

5. The system of claim 1, wherein the manual weld overlay comprises a plurality of weld fusion zones located on first and second sides of the manual weld overlay.

6. The system of claim 5, wherein each weld fusion zone has a length in a range from 1 mm (millimeters) to 3 mm.

7. The system of claim 6, wherein each weld fusion zone has a length of 3 mm.

8. The system of claim 1, wherein the base metal comprises carbon steel.

9. The system of claim 1, wherein the manual weld overlay comprises a 625 grade alloy.

10. The system of claim 1, further comprising one or more gates.

11. A method for non-destructive defect detection, comprising:
providing a system for non-destructive defect detection, the system comprising:
a calibration block comprising:
a base metal having a first surface opposite a second surface;
a corrosion resistant alloy coupled to the first surface of the calibration block; and
a manual weld overlay extending from the first surface of the calibration block to a second surface of the calibration block; and
at least two phased array probes configured to transmit and receive pulsed echo signals; and
calibrating the at least two phased array probes of the system for non-destructive defect detection to form at least two calibrated phased array probes, wherein calibrating the at least two phased array probes comprises:
transmitting pulsed echo signals from each of the at least two phased array probes to an opposite side of the manual weld overlay; and
receiving the transmitted pulsed echo signals in each of the at least two phased array probes.

12. The method of claim 11, wherein providing the system comprises:
providing the manual weld overlay of the calibration block; and
dividing the manual weld overlay into a plurality of zones on a first side of the manual weld overlay and a plurality of zones on a second side of the manual weld overlay.

13. The method of claim 12, wherein the manual weld overlay is provided by the same welding technique as provided to form a welded sample to be evaluated.

14. The method of claim 13, wherein each of the plurality of zones comprises a flat bottom hole in a range from 1 mm to 5 mm.

15. The method of claim 12, further comprising:
preparing a welded sample for evaluation by placing a gate on the welded sample to cover a weld center line to a far fusion line, thereby providing a scanning section that includes any potential lack of fusion zones.

16. The method of claim 11, further comprising:
installing the at least two phased array probes on the calibration block with inspection angles in a range from 88° to 92°; and
installing at least two calibrated probes on at least two sections of a welded sample.

17. The method of claim 16, further comprising:
adjusting a volume of an incident signal from one or more adjacent zones from 6 dB (decibels) to 14 dB.

18. The method of claim 16, further comprising:
adjusting a sensitivity for one or more signals received from one or more calibration reflectors by each of the at least two phased array probes.

19. The method of claim 18, further comprising:
adjusting the sensitivity a value in a range from 75 to 99% full screen height.

20. The method of claim 16, further comprising:
scanning a volumetric indication of the sample with a sectoral phased array scan with the at least two probes, wherein areas that are not covered by a pulse channel of the at least two probes are scanned with a creep probe.
